(19) United States
(12) Patent Application Publication
(10) Pub. No.: US 2025/0330568 A1
(43) Pub. Date: Oct. 23, 2025

(54) UPDATING MOTION ATTRIBUTES OF MERGE CANDIDATES

(71) Applicant: MEDIATEK INC., Hsinchu City (TW)

(72) Inventors: Hsin-Yi TSENG, Hsinchu City (TW); Yu-Ling HSIAO, Hsinchu City (TW); Chih-Wei HSU, Hsinchu City (TW)

(21) Appl. No.: 18/870,636

(22) PCT Filed: Jun. 5, 2023
(86) PCT No.: PCT/CN2023/098399

§ 371 Date: Nov. 29, 2024

Related U.S. Application Data
(60) Provisional application No. 63/349,171, filed on Jun. 6, 2022.

(51) Int. Cl. H04N 19/105; H04N 19/139; H04N 19/167; H04N 19/172; H04N 19/176; H04N 19/182; H04N 19/52

(52) U.S. Cl. CPC H04N 19/105; H04N 19/139; H04N 19/167; H04N 19/172; H04N 19/176; H04N 19/182; H04N 19/52

(57) ABSTRACT

A method for improving merge mode prediction by modifying motion attributes is provided. A video coder receives data for a block of pixels to be encoded or decoded as a current block of a current picture of a video. The video coder generates a list of merge candidates for the current block. The video coder modifies the list of merge candidates by changing a motion attribute of a merge candidate from a first value to a second value. The video coder signals or receives a selection of a merge candidate from the modified list of merge candidates. The video coder encodes or decodes the current block by using the selected merge candidate. The motion attribute may be an inter prediction direction, a reference index, a Bi-prediction with CU-level weight (BCW) index, a Local Illumination Compensation (LIC) flag, a half-pel filter used, or a Multi-Hypothesis Prediction (MHP) weight index.

### CROSS REFERENCE TO RELATED PATENT APPLICATION(S)

The present disclosure is part of a non-provisional application that claims the priority benefit of U.S. Provisional Patent Application No. 63/349,171, filed on 6 Jun. 2022. Contents of above-listed applications are herein incorporated by reference.

### TECHNICAL FIELD

The present disclosure relates generally to video coding. In particular, the present disclosure relates to methods of coding pixel blocks by motion information.

### BACKGROUND

Unless otherwise indicated herein, approaches described in this section are not prior art to the claims listed below and are not admitted as prior art by inclusion in this section.

High-Efficiency Video Coding (HEVC) is an international video coding standard developed by the Joint Collaborative Team on Video Coding (JCT-VC). HEVC is based on the hybrid block-based motion-compensated DCT-like transform coding architecture. The basic unit for compression, termed coding unit (CU), is a 2N×2N square block of pixels, and each CU can be recursively split into four smaller CUs until the predefined minimum size is reached. Each CU contains one or multiple prediction units (PUs).

Versatile video coding (VVC) is the latest international video coding standard developed by the Joint Video Expert Team (JVET) of ITU-T SG16 WP3 and ISO/IEC JTC1/SC29/WG11. The input video signal is predicted from the reconstructed signal, which is derived from the coded picture regions. The prediction residual signal is processed by a block transform. The transform coefficients are quantized and entropy coded together with other side information in the bitstream. The reconstructed signal is generated from the prediction signal and the reconstructed residual signal after inverse transform on the de-quantized transform coefficients. The reconstructed signal is further processed by in-loop filtering for removing coding artifacts. The decoded pictures are stored in the frame buffer for predicting the future pictures in the input video signal.

In VVC, a coded picture is partitioned into non-overlapped square block regions represented by the associated coding tree units (CTUs). The leaf nodes of a coding tree correspond to the coding units (CUs). A coded picture can be represented by a collection of slices, each comprising an integer number of CTUs. The individual CTUs in a slice are processed in raster-scan order. A bi-predictive (B) slice may be decoded using intra prediction or inter prediction with at most two motion vectors and reference indices to predict the sample values of each block. A predictive (P) slice is decoded using intra prediction or inter prediction with at most one motion vector and reference index to predict the sample values of each block. An intra (I) slice is decoded using intra prediction only.

A CTU can be partitioned into one or multiple non-overlapped coding units (CUs) using the quadtree (QT) with nested multi-type-tree (MTT) structure to adapt to various local motion and texture characteristics. A CU can be further split into smaller CUs using one of the five split types: quad-tree partitioning, vertical binary tree partitioning, horizontal binary tree partitioning, vertical center-side triple-tree partitioning, horizontal center-side triple-tree partitioning.

Each CU contains one or more prediction units (PUs). The prediction unit, together with the associated CU syntax, works as a basic unit for signaling the predictor information. The specified prediction process is employed to predict the values of the associated pixel samples inside the PU. Each CU may contain one or more transform units (TUs) for representing the prediction residual blocks. A transform unit (TU) is comprised of a transform block (TB) of luma samples and two corresponding transform blocks of chroma samples and each TB correspond to one residual block of samples from one color component. An integer transform is applied to a transform block. The level values of quantized coefficients together with other side information are entropy coded in the bitstream. The terms coding tree block (CTB), coding block (CB), prediction block (PB), and transform block (TB) are defined to specify the 2-D sample array of one color component associated with CTU, CU, PU, and TU, respectively. Thus, a CTU consists of one luma CTB, two chroma CTBs, and associated syntax elements. A similar relationship is valid for CU, PU, and TU.

For each inter-predicted CU, motion parameters consisting of motion vectors, reference picture indices and reference picture list usage index, and additional information are used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU. The alternative to merge mode is the explicit transmission of motion parameters, where motion vector, corresponding reference picture index for each reference picture list and reference picture list usage flag and other needed information are signalled explicitly per each CU.

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

Some embodiments of the disclosure provide a method for improving merge mode prediction by modifying motion attributes. A video coder receives data for a block of pixels to be encoded or decoded as a current block of a current picture of a video. The video coder generates a list of merge candidates for the current block. The video coder modifies the list of merge candidates by changing a motion attribute of a merge candidate from a first value to a second value. The video coder signals or receives a selection of a merge candidate from the modified list of merge candidates. The video coder encodes or decodes the current block by using the selected merge candidate.

In some embodiments, the list of merge candidates is modified when changing the motion attribute of the first merge candidate improves an estimated cost of using the first merge candidate to encode the current block by more than a threshold. In some embodiments, the estimated cost is a template matching cost (TM cost) computed by determining a difference between (i) a current template region neighboring the current block and (ii) a reference template region neighboring a reference block that is identified by the first merge candidate. In some embodiments, the encoder computes a template matching (TM) cost for each merge candidate in the list of merge candidates and reorders the list according to the computed template matching costs of the merge candidates in the list. The selection of the merge candidate is based on the reordered list.

In some embodiments, the list of merge candidates is modified by adding a second merge candidate having the modified motion attribute. In some embodiments, the list of merge candidates is modified by replacing the first merge candidate with a second merge candidate having the modified motion attribute.

The motion attribute being changed may be an inter prediction direction, a reference index, a Bi-prediction with CU-level weight (BCW) index, a Local Illumination Compensation (LIC) flag, a half-pel filter used, or a Multi-Hypothesis Prediction (MHP) weight index. In some embodiments, the encoder changes the motion attribute of the first merge candidate by changing a reference index from identifying a first reference picture to identifying a second reference picture. The encoder may change the motion attribute of the first merge candidate by scaling a motion vector based on picture order count (POC) distances of the first reference picture and the second reference picture. In some embodiments, the encoder changes the motion attribute of the first merge candidate by changing a bi-prediction weighting index (e.g., BCW index) to select a different weighting for combining a first (e.g., L0) inter-prediction and a second (e.g., L1) inter-prediction.

### BRIEF DESCRIPTION OF THE DRAWINGS

The accompanying drawings are included to provide a further understanding of the present disclosure, and are incorporated in and constitute a part of the present disclosure. The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIG. 1 illustrates changing the reference index of a merge candidate for a current block in a current picture.

FIG. 2 conceptually illustrates updating a motion attribute of a merge candidate based on template matching (TM) cost.

FIG. 3 conceptually illustrates adding predetermined candidates and new merge candidates having changed motion attributes into a merge candidate list.

FIG. 4A illustrates current samples and reference samples that are used to compute the template matching cost of a merge candidate for a current block.

FIG. 4B conceptually illustrates the merge candidate list being sorted according to calculated TM costs.

FIG. 5 illustrates an example video encoder that may implement merge mode prediction.

FIG. 6 illustrates portions of the video encoder that generate merge candidate list and modify motion attributes.

FIG. 7 conceptually illustrates a process for modifying motion attributes of merge candidates.

FIG. 8 illustrates an example video decoder that may implement merge mode prediction.

FIG. 9 illustrates portions of the video decoder that generate merge candidate list and modify motion attributes.

FIG. 10 conceptually illustrates a process for modifying motion attributes of merge candidates.

FIG. 11 conceptually illustrates an electronic system with which some embodiments of the present disclosure are implemented.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

### I. Motion Attributes of a Merge Candidate

When the list of merge candidates is initially constructed for the current block (a block of pixels currently being encoded or decoded), the list includes a set of predetermined merge candidates. Each predetermined merge candidate has a set of motion attributes that may include (but not limited to) the candidate's inter-prediction directions (uni-/bi-prediction), reference index or indices, Bi-prediction with CU-level weight (BCW) index, Local Illumination Compensation (LIC) flag, half-pel filter used, Multi-Hypothesis Prediction (MHP) weight index, etc.

a. Bi-Prediction with CU-Level Weight (BCW)

Bi-prediction with CU-level Weight (BCW) is a coding tool that is used to enhance bidirectional prediction. BCW allows applying different weights to L0 prediction and L1 prediction before combining them to produce the bi-prediction for the CU. For a CU to be coded by BCW, one weighting parameter w is signaled for both L0 and L1 prediction, such that the bi-prediction result P_{bi-pred} is computed based on w according to the following:

$${P}_{bi - pred} = ( ( 8 - w ) * {P}_{0} + w * {P}_{1} + 4 ) ≫ 3$$

P₀ represents pixel values predicted by L0 MV (or L0 prediction). P₁ represents pixel values predicted by L1 MV (or L1 prediction). P_{bi-pred} is the weighted average of P₀ and P₁ according to w. For low delay pictures, i.e., pictures using reference frames with small picture order counts (POCs), the possible values for w include {−2, 3, 4, 5, 10}, these are also referred to as BCW candidate weights. For non-low-delay pictures, the possible values for w (BCW candidate weights) include {3, 4, 5}. In some embodiments, for merge mode, weights are extended from {−2, 3, 4, 5, 10} to {−4, −3, −2, −1, 1, 2, 3, 4, 5, 6, 7, 9, 10, 11, 12} or any subset of above. When negative bi-predicted weights are not supported, weights for merge mode are extended from {−2, 3, 4, 5, 10} to {1, 2, 3, 4, 5, 6, 7}. In addition, the negative bi-predicted weights for non-merge mode are replaced with positive weights, that is, the weights {−2, 10} is replaced with {1, 7}.

### B. Local Illumination Compensation (LIC)

LIC is an inter prediction technique to model local illumination variation between current block and its prediction block as a function of that between current block template and reference block template. The parameters of the function can be denoted by a scale a and an offset β, which forms a linear equation, that is, α*p[x]+β to compensate illumination changes, where p[x] is a reference sample pointed to by MV at a location x on reference picture. In some embodiments, since the parameters α and β can be derived based on current block template and reference block template, no signaling overhead is required for them. The video encoder may signal an LIC flag to enable or disable the use of LIC.

### C. Multi-Hypothesis Prediction (MHP)

In the multi-hypothesis inter prediction mode (MHP), one or more additional motion-compensated prediction signals are signaled, in addition to the conventional Bi-prediction signal. The resulting overall prediction signal is obtained by sample-wise weighted superposition. With the bi prediction signal phi and the first additional inter prediction signal/hypothesis h₃, the resulting prediction signal p₃ is obtained according to

$${p}_{3} = ( 1 - α ) {p}_{bi} + α {h}_{3}$$

The weighting factor α is specified by a syntax element add_hyp_weight_idx in the bitstream of coded video (e.g., add_hyp_weight_idx=0, α=4; add_hyp_weight_idx=1, α=−⅛.)

In some embodiments, more than one additional prediction signal can be used. The resulting overall prediction signal is accumulated iteratively with each additional prediction signal.

$${p}_{n + 1} = ( 1 - {α}_{n + 1} ) {p}_{n} + {α}_{n + 1} {h}_{n + 1}$$

The resulting overall prediction signal is obtained as the last pₙ (i.e., the pₙ having the largest index n). In some embodiments, up to two additional prediction signals can be used (i.e., n is limited to 2). The motion parameters of each additional prediction hypothesis can be signaled either explicitly by specifying a reference index, a motion vector predictor index, and a motion vector difference, or implicitly by specifying a merge index. A separate multi-hypothesis merge flag may distinguish between these two signalling modes.

### II. Updating Motion Attributes of a Merge Candidate

To improve video coding efficiency, some embodiments of the disclosure provide a method in which motion attributes of merge candidates may be changed or updated. This is in contrast with obtaining merge candidates in a pre-determined manner, where the motion attributes are kept unchanged.

In some embodiments, the inter prediction directions of a merge candidate can be changed as a motion attribute. For example, a bi-prediction merge candidate with both L0 and L1 predictions can be changed to a candidate with only L0 prediction, and/or to a candidate with only L1 prediction. A candidate with only L0 prediction or only L1 prediction can be changed to a candidate with both L0 and L1 predictions.

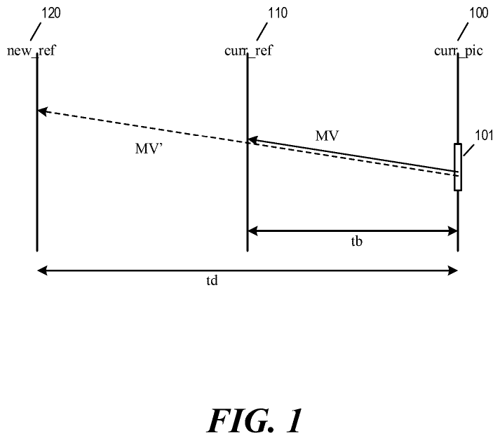

In some embodiments, the reference index of a merge candidate can be changed as a motion attribute. The motion vector of the merge candidate may be scaled according to a scaling factor that is determined based on the picture order count (POC) distances between reference pictures and the current picture. (POC are indices assigned to individual pictures in a video sequence to indicate their temporal ordering or temporal position in the video). FIG. 1 illustrates changing the reference index of a merge candidate for a current block 101 in a current picture 100. The merge candidate originally (when predefined) has a reference index that locates a reference picture 110 (curr_ref), with POC distance of tb from the current picture 100. The changed reference index locates a different reference picture 120 (new_ref), with POC distance of td from the current picture 100. A motion vector MV that originally references samples in the reference picture 110 is scaled to become a scaled motion vector MV′ to reference samples in the reference picture 120, based on a scaling factor of td/tb.

In some embodiments, the reference index can be changed so that the target reference picture can be changed to any reference picture in the available reference lists (e.g., L0 reference list, L1 reference list). For example, a L0 reference index 1 reference picture can be changed to a L0 reference index 0 reference picture, or a L1 reference index 1 reference picture. Thus, for a merge candidate having motion attribute of a bi-prediction motion vector with reference indices (RefIdx_L0, RefIdx L1), Refldx_L0 or RefIdx_L1 can be changed to any value between 0 to N−1, where N is the length of L0 and L1 reference list. Thus, the reference indices of the merge candidate can be changed to any of (0,0), (0,1), . . . , (0,N−1), (1,0), (1,1), . . . , (1,N−1), . . . (N−1,N−1). For a merge candidate having motion attribute of a uni-prediction motion vector with reference index (RefIdx) and reference list (RefList=L1, i=0 or 1), RefList can be changed to L0 or L1. RefIdx can be changed to any value between 0 to N−1, where N is the length of L0 and L1 reference list. Thus, the reference index and the reference list of the merge candidate can be changed to any of (0, L0), (1,L0), . . . , (N−1,L0), (0,L1), (1,L1), . . . , (N−1,L1).

In some embodiments, the reference index is allowed to change to only pictures for which the scaling factor (based on POC) is not greater than one. In some embodiments, in the case where L0 reference list and L1 reference list are identical, and the new inter prediction direction is bi-prediction, the L0 and L1 reference indices are allowed to change only if the new L0 reference picture and the new L1 reference picture (indicated by the changed L0 and L1 reference indices) are two different pictures. For example, in low-delay B configuration, the POC of the reference pictures in the reference list are all smaller than the current picture, and L0 reference list is the same as the L1 reference list.

In some embodiments, in the case where the video is coded in random access configuration and the new inter prediction direction is bi-prediction, the two reference indices are only allowed to change if the new reference pictures indicated by the changed indices provide true bi-prediction (e.g., the new L0 and L1 reference pictures are in opposite temporal directions relative to the current picture). When a video is coded in random access configuration, the POC of a reference picture in the reference list could be smaller or larger than the POC of the current picture. In some other embodiments, a reference index is allowed to change only if the new reference picture indicated by the changed reference index remain in the same reference list. For example, if a reference index, denoted by RefIdxL0, specifies a reference picture used in L0 reference list, the new RefldxL0 also specifies a reference picture used in L0 reference list.

In some embodiments, the BCW weight as indicated by the BCW index of a merge candidate can be changed as a motion attribute. The BCW index value can be selected among the allowed values in current video coding setting. In some embodiments, the BCW index can be changed to indicate equal weighting, or to any other BCW index. In some embodiments, the merge candidate's BCW index can be changed only if the BCW index indicates non-equal weighting (to a BCW index that indicates equal weighting or another BCW index that indicates non-equal weighting.) In some embodiments, when the merge candidate's BCW index indicates positive value, the BCW index is only allowed to be changed to indicate another positive value.

In some embodiments, the merge candidate's LIC flag can be changed. The LIC flag can be changed from true (e.g., indicating LIC enabled) to false (e.g., indicating LIC disabled), and vice versa.

In some embodiments, the half-pel filter used by the merge candidate can be changed as a motion attribute. For example, the merge candidate can be changed from using a 6-tap interpolation filter to using a default 8-tap interpolation filter for the half-luma sample position, and vice versa.

In some embodiment, the MHP weight index used by the merge candidate can be changed as a motion attribute. For example, the MHP weight index can be changed from 0 to 1, or vice versa.

### III. Updating Merge Candidate List

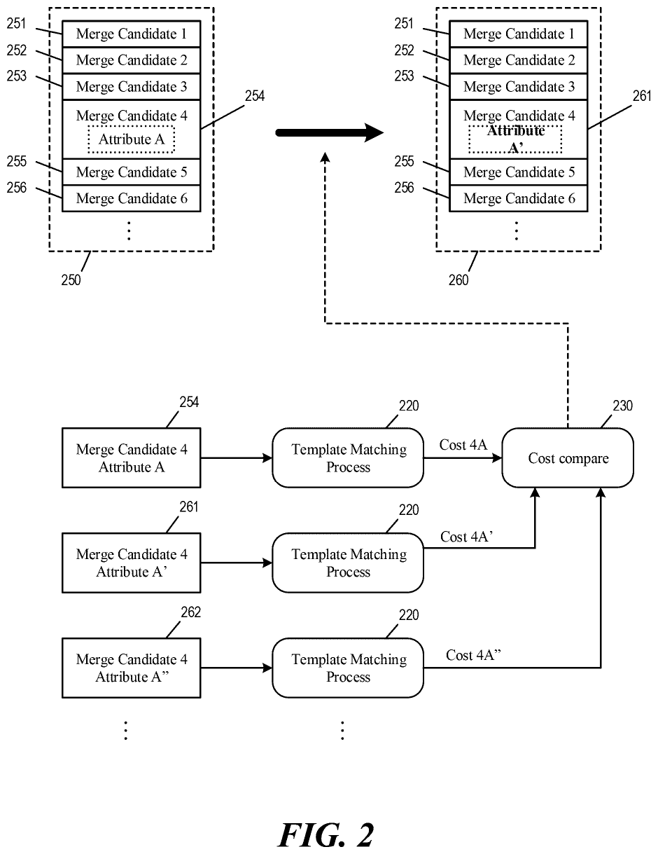

In some embodiments, for each pre-determined candidate in a merge candidate list, the candidate's motion attribute can be changed based on TM cost evaluation. Specifically, in some embodiments, if changing a motion attribute of a pre-determined merge candidate results in a TM cost that is smaller by a threshold than that of the pre-determined merge candidate with its original motion attributes, the pre-determined merge candidate is replaced with an updated merge candidate having the changed motion attributes. FIG. 2 conceptually illustrates updating a motion attribute of a merge candidate based on TM cost.

As illustrated, a merge candidate list 250 for a current block being coded is initially populated by predetermined merge candidates 251-256. Each merge candidate may have a set of motion attributes that may include the candidate's inter prediction directions, reference index or indices, BCW index, LIC flag, half-pel filter used, MHP weight index, etc. In the example, a predetermined merge candidate 254 (merge candidate 4) has a set of motion attributes, denoted as Attribute A. The video coder examines several possible changes to Attribute A of the merge candidate 254, including Attribute A′ and Attribute A″

A template matching process 220 is applied to compute the TM costs of the original predetermined merge candidate 254 and of modified merge candidates 261 and 262. (The modified merge candidate 261 has the modified motion attribute A′ and the modified merge candidate 262 has the modified motion attribute A″.) Based on the computed TM costs, a cost comparison process 230 is applied to determine whether to replace/update/modify the merge candidate 254 with a modified merge candidate with a changed motion attribute. In the example, the merge candidate 254 is replaced with the modified merge candidate 261 (with Attribute A′).

In some embodiments, if none of the modified merge candidates (e.g., 261 and 262) has a TM cost that is lower than that of the original predetermined merge candidate 254 by more than a threshold, the original predetermined merge candidate 254 shall not be replaced or modified. Conversely, if a modified merge candidate has a TM cost that is lower than that of the original predetermined merge candidate 254 by more than the threshold, the modified merge candidate (261 in the example) may replace the original predetermined merge candidate 254 in the merge candidate list 250.

In some embodiments, a candidate reordering process is performed on the updated merge candidate list 260 based on the TM costs of the candidates in the list. In some embodiments, the reordering process is performed according to an TM process described in Section IV below.

In some embodiments, to create a merge candidate list, in addition to the pre-determined merge candidates, merge candidates with changed motion attributes are also added into the merge candidate list. In some embodiments, such a merge candidate list has a pre-determined size upper-bound. The TM process may then be performed on the created merge candidate list that includes the candidates with the changed motion attributes.

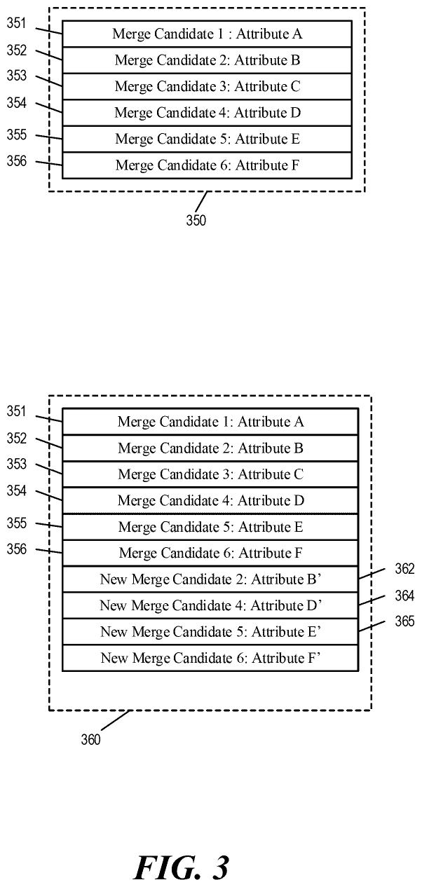

FIG. 3 conceptually illustrates adding predetermined candidates and new merge candidates having changed motion attributes into a merge candidate list. In the example, a merge candidate list 350 for a current block originally has predetermined merge candidate 351-356, each having a set of original motion attributes. The video coder then adds new merge candidates 362, 364, and 365 into the merge candidate list 350 (to become updated merge candidate list 360). The added new merge candidates 362, 364, and 365 have the modified motion attributes (B′, D′, E′) of the predetermined merge candidates 352, 354, and 355, respectively.

In some embodiments, the pre-determined candidates and the candidates with changed motion attributes are added into the merge candidate list in some pre-determined order. For example, in some embodiments, the pre-determined candidates can be added into the list first before all the candidates with changed motion attributes are added. For another example, a first pre-determined candidate and the candidates with changed motion attributes created from this first pre-determined candidate may be added as a first group into the list, then a second pre-determined candidate and the candidates created with changed motion attributes created from this second pre-determined candidate are added as a second group to the list, etc.

In some embodiments, some attribute changes may be preferred when updating the merge candidate list. Thus, new merge candidates having the preferred motion attribute changes are added to the list before other new candidates with other motion attribute changes. For example, reference indices may be the preferred motion attribute to have changes. Thus, a pre-determined merge candidate is added to the merge candidate list, then one or more new candidates with changed reference indices based on the pre-determined merge candidate are added to the list. Other pre-determined merge candidates may then be added. Then new merge candidates with changed motion attributes that do not include reference index change are added in the last.

### IV. Template Matching (TM) Cost

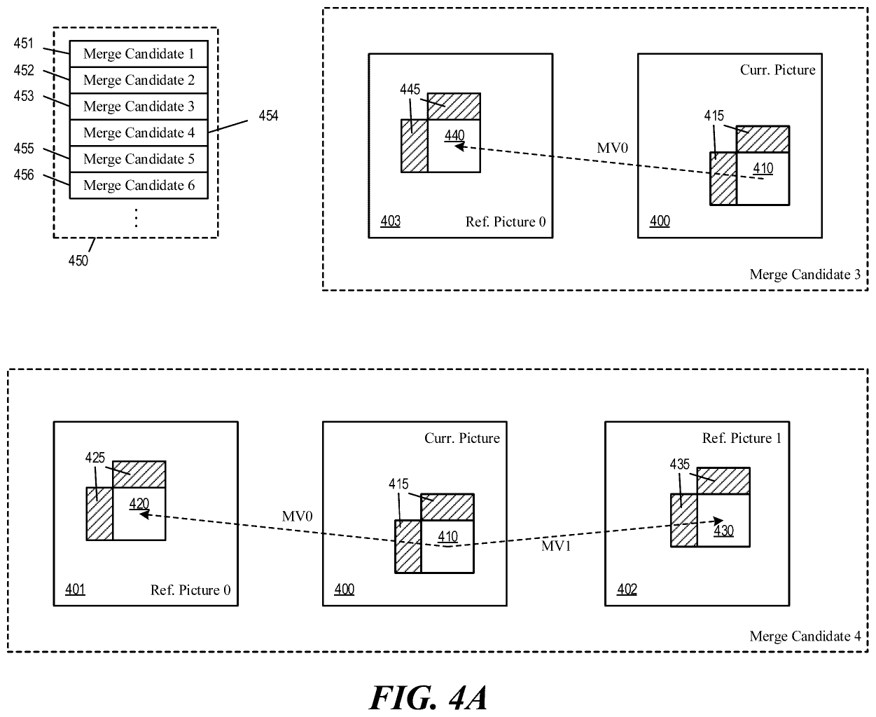

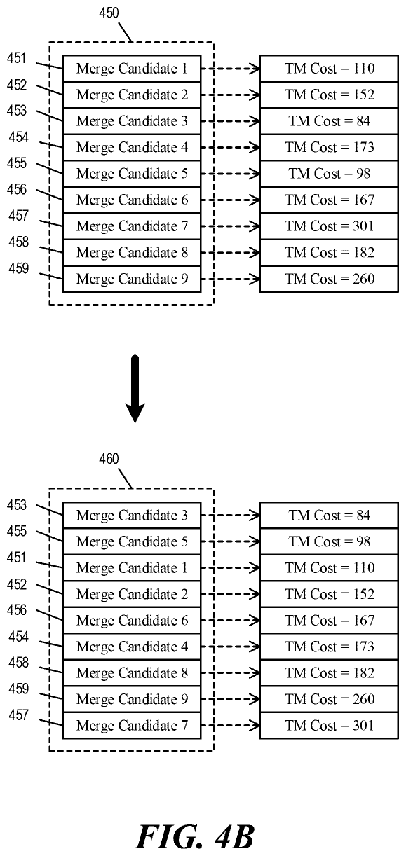

In some embodiments, the template matching cost of a merge candidate is measured by the sum of absolute differences (SAD) between samples of a current template and their corresponding samples in a reference template identified by the merge candidate. FIG. 4A illustrates current samples and reference samples that are used to compute the template matching cost of a merge candidate for a current block 410. In some embodiments, the template matching cost of a merge candidate is measured by the sum of absolute transformed differences (SATD) between samples of a current template and their corresponding samples in a reference template identified by the merge candidate. In some embodiments, the template matching cost of a merge candidate is measured by a combination of SAD and SATD between samples of a current template and their corresponding samples in a reference template identified by the merge candidate.

The current block 410 is in a current picture 400. A set of reconstructed samples neighboring the current block 410 is used as a current template 415. The current block is associated with a merge candidate list 450 that includes merge candidates 451-456. Among these, the merge candidate 454 is a bi-prediction candidate having motion information MV0 and MV1. MV0 locates a reference block 420 in a L0 reference picture 401. MV1 locates a reference block 430 in a L1 reference picture 402. Collocated reference samples of the current template 415 are located by MV0 in a reference template 425, and by MV1 in a reference template 435. The final reference samples are generated by samples of the reference templates 425 and 435 by bi-prediction, based on the motion attributes of the merge candidate 454. The template matching cost of the merge candidate 454 is the difference between the samples of the current template 415 and the final reference samples. The difference may be measured by SAD, SATD or a combination of SAD and SATD.

The template matching cost can also be calculated for a uni-prediction merge candidate. The merge candidate 453 is a uni-prediction candidate having motion information MV0. MV0 locates a reference block 440 in a L0 reference picture 403. Collocated reference samples of the current template 415 are located by MV0 in a reference template 445. The final reference samples are generated based on the samples of the reference templates 445 and the motion attributes of the merge candidate 453. The template matching cost of the merge candidate 453 is the difference between the samples of the current template 415 and the final reference samples. The difference may be measured by SAD, SATD or a combination of SAD and SATD.

A template matching cost can be calculated for each merge candidate in the merge candidate list 450, and the merge candidate list 450 can then be sorted according to the calculated template-matching costs. FIG. 4B conceptually illustrates the merge candidate list 450 being sorted according to calculated TM costs. In the example, a template matching process is performed for each merge candidate to compute a TM cost, and the merge candidate list 450 is sorted based on the computed TM costs to become a reordered candidate list 460. In some embodiments, the video encoder may examine all merge candidates in the reordered list 460 for determining whether to modify their motion attributes, while the video decoder would examine and modify the motion attribute of only the merge candidate that is selected by the signaled merge candidate index.

In some embodiments, TM cost values are calculated for different bi-prediction weights, and the bi-prediction weight with the minimum TM cost value is used to predict the current block.

Adaptive Reordering of Merge Candidates with Template Matching (ARMC-TM) is a method to re-order merge candidates based on template-matching (TM) cost, where signaling efficiency is improved by sorting merge candidates in ascending order of TM costs. For the TM merge mode, merge candidates are reordered before the refinement process.

In some embodiments, after a merge candidate list is constructed, merge candidates are divided into several subgroups. The subgroup size is set to 5 for regular merge mode and TM merge mode. The subgroup size is set to 3 for affine merge mode. Merge candidates in each subgroup are reordered ascendingly according to cost values based on template matching. In some embodiments, merge candidates in the last but not the first subgroup are not reordered.

For some embodiments, the foregoing proposed method can be either applied to regular ARMC-TM and/or MV candidate type-based ARMC. For example, the proposed method can be applied to TMVP candidate ARMC, and/or non-adjacent MVP (NA-MVP) ARMC, and/or ARMC-TM.

### V. Example Video Encoder

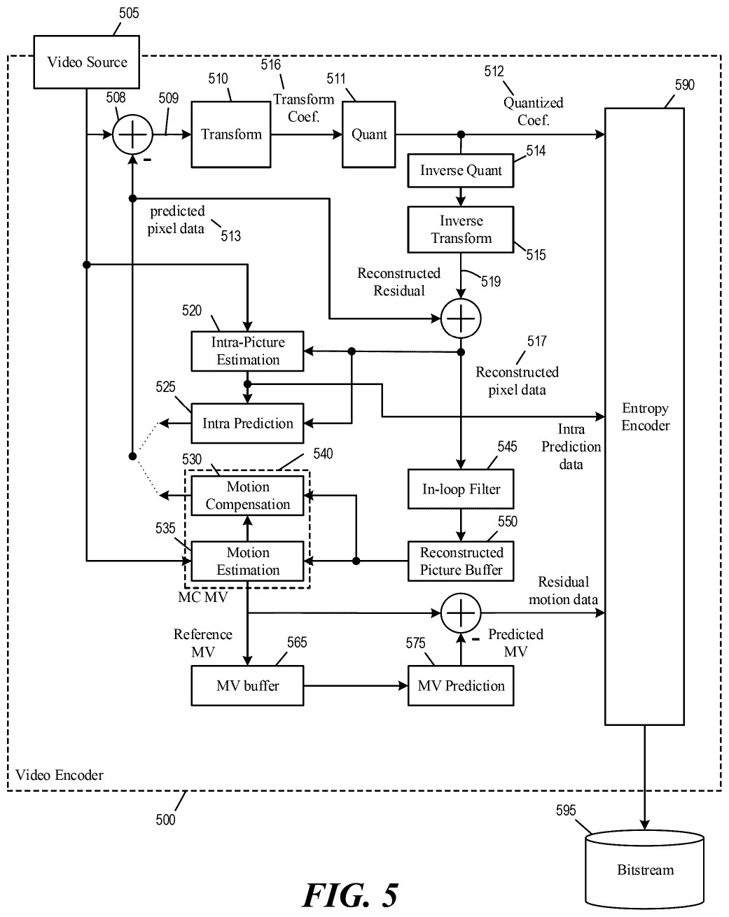

FIG. 5 illustrates an example video encoder 500 that may implement merge mode prediction. As illustrated, the video encoder 500 receives input video signal from a video source 505 and encodes the signal into bitstream 595. The video encoder 500 has several components or modules for encoding the signal from the video source 505, at least including some components selected from a transform module 510, a quantization module 511, an inverse quantization module 514, an inverse transform module 515, an intra-picture estimation module 520, an intra-prediction module 525, a motion compensation module 530, a motion estimation module 535, an in-loop filter 545, a reconstructed picture buffer 550, a MV buffer 565, and a MV prediction module 575, and an entropy encoder 590. The motion compensation module 530 and the motion estimation module 535 are part of an inter-prediction module 540.

In some embodiments, the modules 510-590 are modules of software instructions being executed by one or more processing units (e.g., a processor) of a computing device or electronic apparatus. In some embodiments, the modules 510-590 are modules of hardware circuits implemented by one or more integrated circuits (ICs) of an electronic apparatus. Though the modules 510-590 are illustrated as being separate modules, some of the modules can be combined into a single module.

The video source 505 provides a raw video signal that presents pixel data of each video frame without compression. A subtractor 508 computes the difference between the raw video pixel data of the video source 505 and the predicted pixel data 513 from the motion compensation module 530 or intra-prediction module 525 as prediction residual 509. The transform module 510 converts the difference (or the residual pixel data or residual signal 508) into transform coefficients (e.g., by performing Discrete Cosine Transform, or DCT). The quantization module 511 quantizes the transform coefficients into quantized data (or quantized coefficients) 512, which is encoded into the bitstream 595 by the entropy encoder 590.

The inverse quantization module 514 de-quantizes the quantized data (or quantized coefficients) 512 to obtain transform coefficients, and the inverse transform module 515 performs inverse transform on the transform coefficients to produce reconstructed residual 519. The reconstructed residual 519 is added with the predicted pixel data 513 to produce reconstructed pixel data 517. In some embodiments, the reconstructed pixel data 517 is temporarily stored in a line buffer (not illustrated) for intra-picture prediction and spatial MV prediction. The reconstructed pixels are filtered by the in-loop filter 545 and stored in the reconstructed picture buffer 550. In some embodiments, the reconstructed picture buffer 550 is a storage external to the video encoder 500. In some embodiments, the reconstructed picture buffer 550 is a storage internal to the video encoder 500.

The intra-picture estimation module 520 performs intra-prediction based on the reconstructed pixel data 517 to produce intra prediction data. The intra-prediction data is provided to the entropy encoder 590 to be encoded into bitstream 595. The intra-prediction data is also used by the intra-prediction module 525 to produce the predicted pixel data 513.

The motion estimation module 535 performs inter-prediction by producing MVs to reference pixel data of previously decoded frames stored in the reconstructed picture buffer 550. These MVs are provided to the motion compensation module 530 to produce predicted pixel data.

Instead of encoding the complete actual MVs in the bitstream, the video encoder 500 uses MV prediction to generate predicted MVs, and the difference between the MVs used for motion compensation and the predicted MVs is encoded as residual motion data and stored in the bitstream 595.

The MV prediction module 575 generates the predicted MVs based on reference MVs that were generated for encoding previously video frames, i.e., the motion compensation MVs that were used to perform motion compensation. The MV prediction module 575 retrieves reference MVs from previous video frames from the MV buffer 565. The video encoder 500 stores the MVs generated for the current video frame in the MV buffer 565 as reference MVs for generating predicted MVs.

The MV prediction module 575 uses the reference MVs to create the predicted MVs. The predicted MVs can be computed by spatial MV prediction or temporal MV prediction. The difference between the predicted MVs and the motion compensation MVs (MC MVs) of the current frame (residual motion data) are encoded into the bitstream 595 by the entropy encoder 590.

The entropy encoder 590 encodes various parameters and data into the bitstream 595 by using entropy-coding techniques such as context-adaptive binary arithmetic coding (CABAC) or Huffman encoding. The entropy encoder 590 encodes various header elements, flags, along with the quantized transform coefficients 512, and the residual motion data as syntax elements into the bitstream 595. The bitstream 595 is in turn stored in a storage device or transmitted to a decoder over a communications medium such as a network.

The in-loop filter 545 performs filtering or smoothing operations on the reconstructed pixel data 517 to reduce the artifacts of coding, particularly at boundaries of pixel blocks. In some embodiments, the filtering or smoothing operations performed by the in-loop filter 545 include deblock filter (DBF), sample adaptive offset (SAO), and/or adaptive loop filter (ALF).

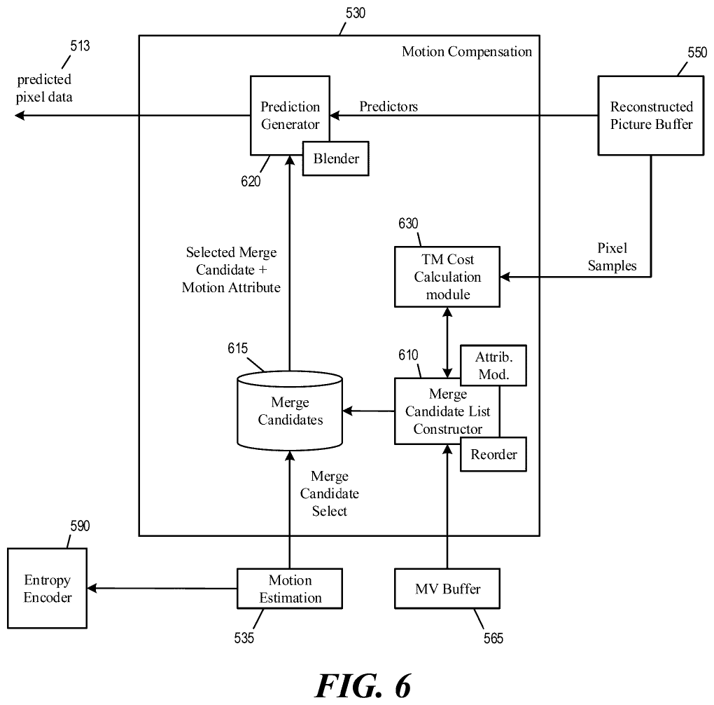

FIG. 6 illustrates portions of the video encoder 500 that generate merge candidate list and modify motion attributes. Specifically, the figure illustrates the components of the motion compensation module 530 of the video encoder 500.

As illustrated, the motion compensation module 530 has a merge candidate list constructor 610 that generates a list of merge candidates 615. The list 615 is initially generated based on previously generated MVs stored in the MV buffer 565 and includes predetermined merge candidates. The merge candidate list constructor 610 may modify the motion attributes of the predetermined merge candidates and reorder the candidates in the list 615. The merge candidate list constructor 610 may also add additional merge candidates into the list 615 based on modified motion attributes. The modification and the reordering may be based on TM costs computed by a TM cost calculation module 630 for individual merge candidates with or without modified motion attributes. The template matching operations are performed based on pixel samples stored in the reconstructed picture buffer 550, which may include samples of the current template neighboring the current block and samples of the reference templates neighboring reference blocks. The reference blocks may be located by the motion information that are determined according to the motion attributes of individual merge candidates. Examples of motion attributes of merge candidates are described by Section I above.

The motion estimation module 535 provides the selection one of the merge candidates from the list 615, which may have been reordered and/or modified by the merge candidate list constructor 610 as described above. The selection of the merge candidate is also provided to the entropy encoder 590 to be signaled as a merge index. The selected merge candidate and its associated motion attributes are provided to a prediction generator 620, which fetches corresponding prediction pixels from the reconstructed picture buffer 550. The prediction generator 620 may perform blending based on weighting factors specified by the motion attributes of the selected merge candidate.

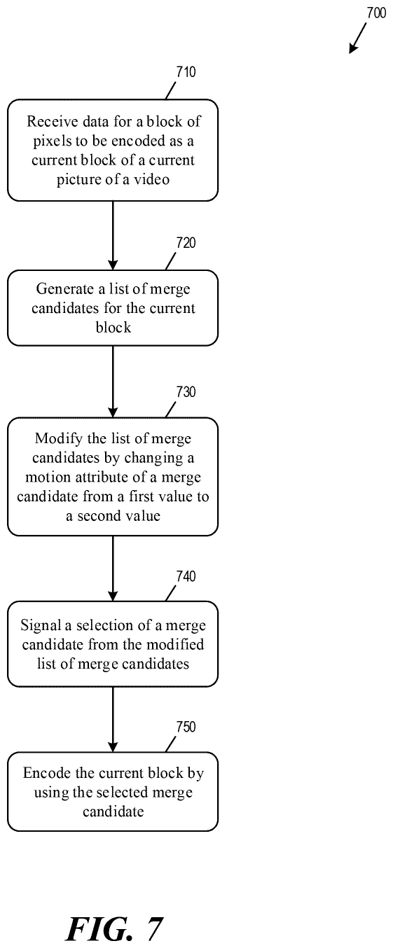

FIG. 7 conceptually illustrates a process 700 for modifying motion attributes of merge candidates. In some embodiments, one or more processing units (e.g., a processor) of a computing device implementing the encoder 500 performs the process 700 by executing instructions stored in a computer readable medium. In some embodiments, an electronic apparatus implementing the encoder 500 performs the process 700.

The encoder receives (at block 710) data to be encoded as a current block of pixels in a current picture of a video.

The encoder generates (at block 720) a list of merge candidates for the current block. Each merge candidate is associated with a motion attribute that may an inter prediction direction, a reference index, a Bi-prediction with CU-level weight (BCW) index, a Local Illumination Compensation (LIC) flag, a half-pel filter used, or a Multi-Hypothesis Prediction (MHP) weight index.

The encoder modifies (at block 730) the list of merge candidates by changing a motion attribute of a first merge candidate from a first value to a second value. In some embodiments, the list of merge candidates is modified when changing the motion attribute of the first merge candidate improves an estimated cost of using the first merge candidate to encode the current block by more than a threshold. In some embodiments, the estimated cost is a template matching cost (TM cost) computed by determining a difference between (i) a current template region neighboring the current block and (ii) a reference template region neighboring a reference block that is identified by the first merge candidate. Other cost measures may also be used as the estimated cost, such as a boundary matching (BM) cost that is computed by determining a discontinuity measure along the boundary of the current block (e.g., between reconstructed neighboring samples and predicted samples of the current block.)

In some embodiments, the list of merge candidates is modified by adding a second merge candidate having the modified motion attribute. In some embodiments, the list of merge candidates is modified by replacing the first merge candidate with a second merge candidate having the modified motion attribute.

In some embodiments, the encoder changes the motion attribute of the first merge candidate by changing a reference index from identifying a first reference picture to identifying a second reference picture. The encoder may change the motion attribute of the first merge candidate by scaling a motion vector based on picture order count (POC) distances of the first reference picture and the second reference picture. In some embodiments, the encoder changes the motion attribute of the first merge candidate by changing a bi-prediction weighting index (e.g., BCW index) to select a different weighting for combining a first (e.g., L0) inter-prediction and a second (e.g., L1) inter-prediction.

The encoder signals (at block 740) a selection of a merge candidate from the modified list of merge candidates. In some embodiments, the encoder computes a template matching cost for each merge candidate in the list of merge candidates and reorders the list according to the computed template matching costs of the merge candidates in the list. The selection of the merge candidate is based on the reordered list.

The encoder encodes (at block 750) the current block by using the selected merge candidate to generate a prediction and to produce prediction residuals.

### VI. Example Video Decoder

In some embodiments, an encoder may signal (or generate) one or more syntax element in a bitstream, such that a decoder may parse said one or more syntax element from the bitstream.

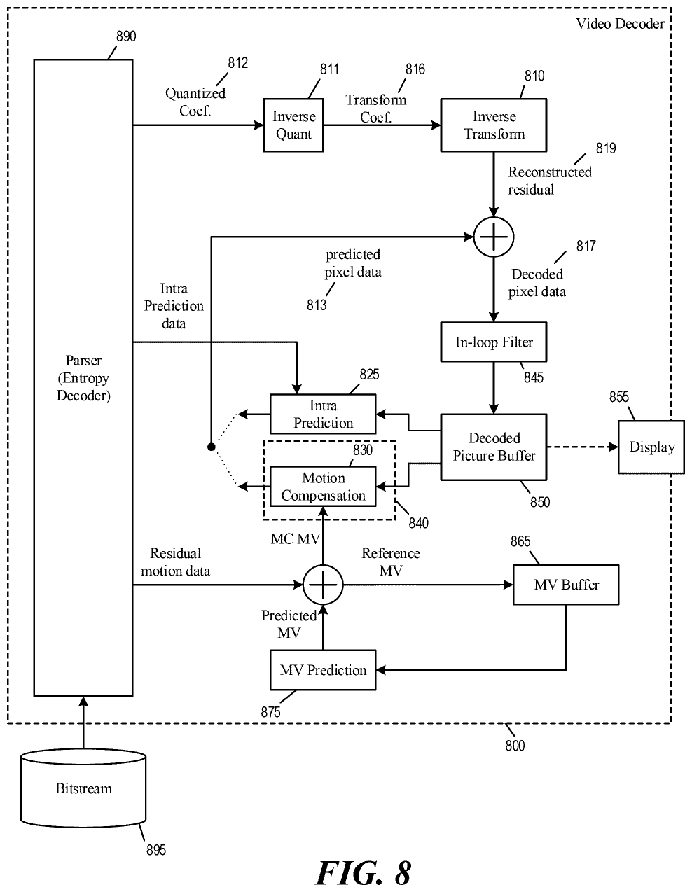

FIG. 8 illustrates an example video decoder 800 that may implement merge mode prediction. As illustrated, the video decoder 800 is an image-decoding or video-decoding circuit that receives a bitstream 895 and decodes the content of the bitstream into pixel data of video frames for display. The video decoder 800 has several components or modules for decoding the bitstream 895, including some components selected from an inverse quantization module 811, an inverse transform module 810, an intra-prediction module 825, a motion compensation module 830, an in-loop filter 845, a decoded picture buffer 850, a MV buffer 865, a MV prediction module 875, and a parser 890. The motion compensation module 830 is part of an inter-prediction module 840.

In some embodiments, the modules 810-890 are modules of software instructions being executed by one or more processing units (e.g., a processor) of a computing device. In some embodiments, the modules 810-890 are modules of hardware circuits implemented by one or more ICs of an electronic apparatus. Though the modules 810-890 are illustrated as being separate modules, some of the modules can be combined into a single module.

The parser 890 (or entropy decoder) receives the bitstream 895 and performs initial parsing according to the syntax defined by a video-coding or image-coding standard. The parsed syntax element includes various header elements, flags, as well as quantized data (or quantized coefficients) 812. The parser 890 parses out the various syntax elements by using entropy-coding techniques such as context-adaptive binary arithmetic coding (CABAC) or Huffman encoding.

The inverse quantization module 811 de-quantizes the quantized data (or quantized coefficients) 812 to obtain transform coefficients, and the inverse transform module 810 performs inverse transform on the transform coefficients 816 to produce reconstructed residual signal 819. The reconstructed residual signal 819 is added with predicted pixel data 813 from the intra-prediction module 825 or the motion compensation module 830 to produce decoded pixel data 817. The decoded pixels data are filtered by the in-loop filter 845 and stored in the decoded picture buffer 850. In some embodiments, the decoded picture buffer 850 is a storage external to the video decoder 800. In some embodiments, the decoded picture buffer 850 is a storage internal to the video decoder 800.

The intra-prediction module 825 receives intra-prediction data from bitstream 895 and according to which, produces the predicted pixel data 813 from the decoded pixel data 817 stored in the decoded picture buffer 850. In some embodiments, the decoded pixel data 817 is also stored in a line buffer (not illustrated) for intra-picture prediction and spatial MV prediction.

In some embodiments, the content of the decoded picture buffer 850 is used for display. A display device 855 either retrieves the content of the decoded picture buffer 850 for display directly, or retrieves the content of the decoded picture buffer to a display buffer. In some embodiments, the display device receives pixel values from the decoded picture buffer 850 through a pixel transport.

The motion compensation module 830 produces predicted pixel data 813 from the decoded pixel data 817 stored in the decoded picture buffer 850 according to motion compensation MVs (MC MVs). These motion compensation MVs are decoded by adding the residual motion data received from the bitstream 895 with predicted MVs received from the MV prediction module 875.

The MV prediction module 875 generates the predicted MVs based on reference MVs that were generated for decoding previous video frames, e.g., the motion compensation MVs that were used to perform motion compensation. The MV prediction module 875 retrieves the reference MVs of previous video frames from the MV buffer 865. The video decoder 800 stores the motion compensation MVs generated for decoding the current video frame in the MV buffer 865 as reference MVs for producing predicted MVs.

The in-loop filter 845 performs filtering or smoothing operations on the decoded pixel data 817 to reduce the artifacts of coding, particularly at boundaries of pixel blocks. In some embodiments, the filtering or smoothing operations performed by the in-loop filter 845 include deblock filter (DBF), sample adaptive offset (SAO), and/or adaptive loop filter (ALF).

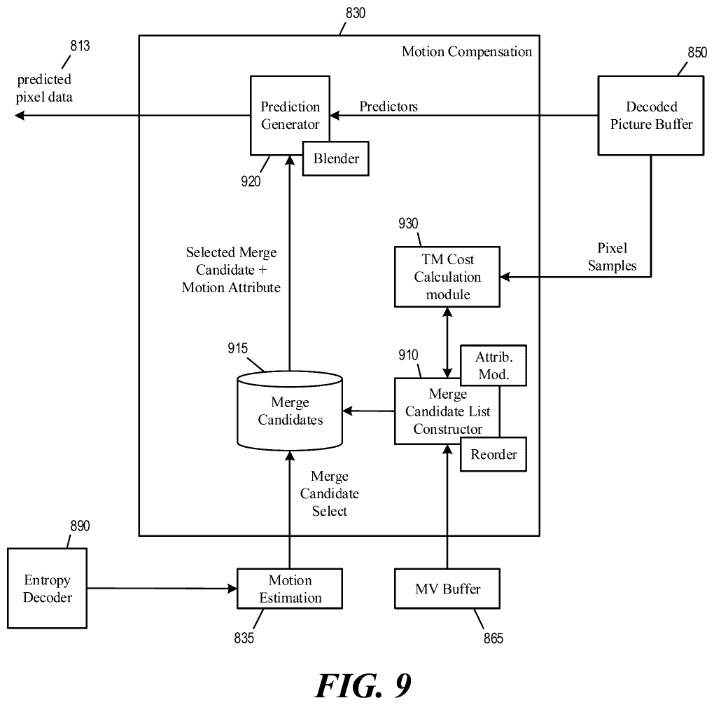

FIG. 9 illustrates portions of the video decoder 800 that generate merge candidate list and modify motion attributes. Specifically, the figure illustrates the components of the motion compensation module 830 of the video decoder 800.

As illustrated, the motion compensation module 830 has a merge candidate list constructor 910 that generates a list of merge candidates 915. The list 915 is initially generated based on previously generated MVs stored in the MV buffer 865 and includes predetermined merge candidates. The merge candidate list constructor 910 may modify the motion attributes of the predetermined merge candidates and reorder the candidates in the list 915. The merge candidate list constructor 910 may also add additional merge candidates into the list 915 based on modified motion attributes. The modification and the reordering may be based on TM costs computed by a TM cost calculation module 930 for individual merge candidates with or without modified motion attributes. The template matching operations are performed based on pixel samples stored in the decoded picture buffer 850, which may include samples of the current template neighboring the current block and samples of the reference templates neighboring reference blocks. The reference blocks may be located by the motion information that are determined according to the motion attributes of individual merge candidates. Examples of motion attributes of merge candidates are described by Section I above.

The entropy decoder 890 may receive a merge index signaled in the bitstream 895. The received merge index is used to select a candidate from the merge candidate list 915, which may have been reordered and/or modified by the merge candidate list constructor 910 as described above. The selected merge candidate and its associated motion attributes are provided to a prediction generator 920, which fetches corresponding prediction pixels from the decoded picture buffer 850. The prediction generator 920 may perform blending based on weighting factors specified by the motion attributes of the selected merge candidate.

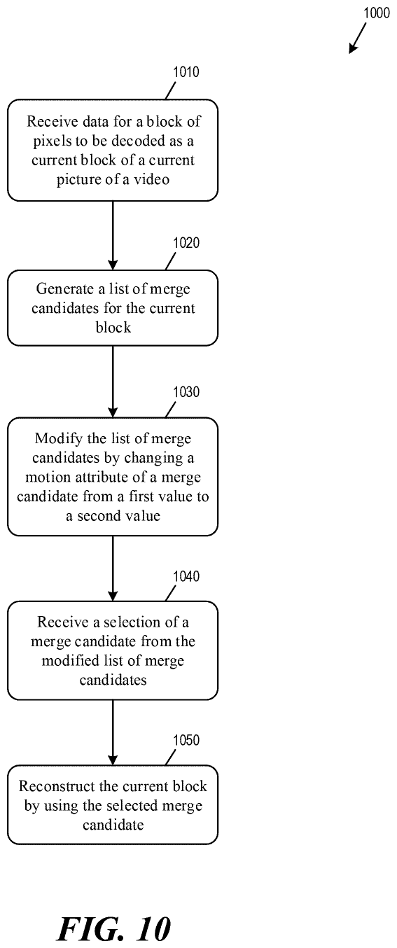

FIG. 10 conceptually illustrates a process 1000 for modifying motion attributes of merge candidates. In some embodiments, one or more processing units (e.g., a processor) of a computing device implementing the decoder 800 performs the process 1000 by executing instructions stored in a computer readable medium. In some embodiments, an electronic apparatus implementing the decoder 800 performs the process 1000.

The decoder receives (at block 1010) data to be decoded as a current block of pixels in a current picture of a video.

The decoder generates (at block 1020) a list of merge candidates for the current block. Each merge candidate is associated with a motion attribute that may an inter prediction direction, a reference index, a Bi-prediction with CU-level weight (BCW) index, a Local Illumination Compensation (LIC) flag, a half-pel filter used, or a Multi-Hypothesis Prediction (MHP) weight index.

The decoder modifies (at block 1030) the list of merge candidates by changing a motion attribute of a first merge candidate from a first value to a second value. In some embodiments, the list of merge candidates is modified when changing the motion attribute of the first merge candidate improves an estimated cost of using the first merge candidate to decode the current block by more than a threshold. In some embodiments, the estimated cost is a template matching cost (TM cost) computed by determining a difference between (i) a current template region neighboring the current block and (ii) a reference template region neighboring a reference block that is identified by the first merge candidate. Other cost measures may also be used as the estimated cost, such as a boundary matching (BM) cost that is computed by determining a discontinuity measure along the boundary of the current block (e.g., between reconstructed neighboring samples and predicted samples of the current block).

In some embodiments, the list of merge candidates is modified by adding a second merge candidate having the modified motion attribute. In some embodiments, the list of merge candidates is modified by replacing the first merge candidate with a second merge candidate having the modified motion attribute.

In some embodiments, the decoder changes the motion attribute of the first merge candidate by changing a reference index from identifying a first reference picture to identifying a second reference picture. The decoder may change the motion attribute of the first merge candidate by scaling a motion vector based on picture order count (POC) distances of the first reference picture and the second reference picture. In some embodiments, the decoder changes the motion attribute of the first merge candidate by changing a bi-prediction weighting index (e.g., BCW index) to select a different weighting for combining a first (e.g., L0) inter-prediction and a second (e.g., L1) inter-prediction.

The decoder receives (at block 1040) a selection of a merge candidate from the modified list of merge candidates. In some embodiments, the decoder computes a template matching cost for each merge candidate in the list of merge candidates and reorders the list according to the computed template matching costs of the merge candidates in the list. The selection of the merge candidate is based on the reordered list.

The decoder reconstructs (at block 1050) the current block by using the selected merge candidate to generate a prediction block. The decoder may then provide the reconstructed current block for display as part of the reconstructed current picture.

### VII. Example Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random-access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

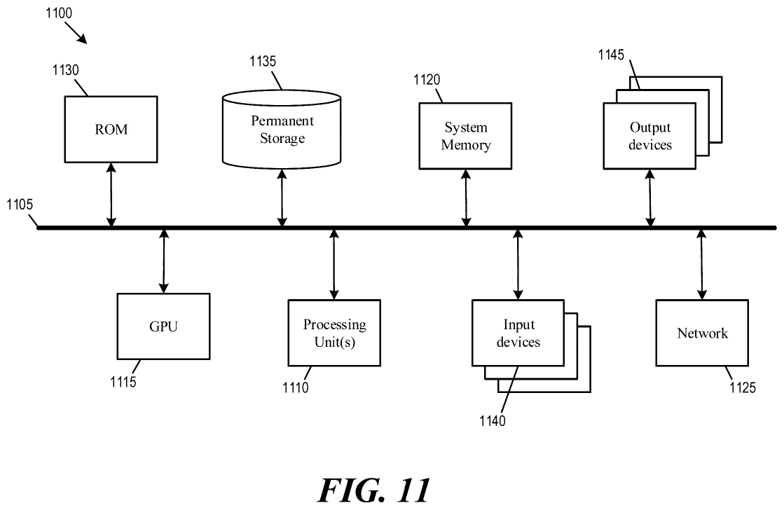

FIG. 11 conceptually illustrates an electronic system 1100 with which some embodiments of the present disclosure are implemented. The electronic system 1100 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 1100 includes a bus 1105, processing unit(s) 1110, a graphics-processing unit (GPU) 1115, a system memory 1120, a network 1125, a read-only memory 1130, a permanent storage device 1135, input devices 1140, and output devices 1145.

The bus 1105 collectively represents all system, peripheral, and chipset buses that communicatively connect the numerous internal devices of the electronic system 1100. For instance, the bus 1105 communicatively connects the processing unit(s) 1110 with the GPU 1115, the read-only memory 1130, the system memory 1120, and the permanent storage device 1135.

From these various memory units, the processing unit(s) 1110 retrieves instructions to execute and data to process in order to execute the processes of the present disclosure. The processing unit(s) may be a single processor or a multi-core processor in different embodiments. Some instructions are passed to and executed by the GPU 1115. The GPU 1115 can offload various computations or complement the image processing provided by the processing unit(s) 1110.

The read-only-memory (ROM) 1130 stores static data and instructions that are used by the processing unit(s) 1110 and other modules of the electronic system. The permanent storage device 1135, on the other hand, is a read-and-write memory device. This device is a non-volatile memory unit that stores instructions and data even when the electronic system 1100 is off. Some embodiments of the present disclosure use a mass-storage device (such as a magnetic or optical disk and its corresponding disk drive) as the permanent storage device 1135.

Other embodiments use a removable storage device (such as a floppy disk, flash memory device, etc., and its corresponding disk drive) as the permanent storage device. Like the permanent storage device 1135, the system memory 1120 is a read-and-write memory device. However, unlike storage device 1135, the system memory 1120 is a volatile read-and-write memory, such a random access memory. The system memory 1120 stores some of the instructions and data that the processor uses at runtime. In some embodiments, processes in accordance with the present disclosure are stored in the system memory 1120, the permanent storage device 1135, and/or the read-only memory 1130. For example, the various memory units include instructions for processing multimedia clips in accordance with some embodiments. From these various memory units, the processing unit(s) 1110 retrieves instructions to execute and data to process in order to execute the processes of some embodiments.

The bus 1105 also connects to the input and output devices 1140 and 1145. The input devices 1140 enable the user to communicate information and select commands to the electronic system. The input devices 1140 include alphanumeric keyboards and pointing devices (also called “cursor control devices”), cameras (e.g., webcams), microphones or similar devices for receiving voice commands, etc. The output devices 1145 display images generated by the electronic system or otherwise output data. The output devices 1145 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 11, bus 1105 also couples electronic system 1100 to a network 1125 through a network adapter (not shown). In this manner, the computer can be a part of a network of computers (such as a local area network (“LAN”), a wide area network (“WAN”), or an Intranet, or a network of networks, such as the Internet. Any or all components of electronic system 1100 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, many of the above-described features and applications are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the present disclosure has been described with reference to numerous specific details, one of ordinary skill in the art will recognize that the present disclosure can be embodied in other specific forms without departing from the spirit of the present disclosure. In addition, a number of the figures (including FIG. 7 and FIG. 10) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the present disclosure is not to be limited by the foregoing illustrative details, but rather is to be defined by the appended claims.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A video coding method comprising:
receiving data for a block of pixels to be encoded or decoded as a current block of a current picture of a video;
generating a list of merge candidates for the current block;
modifying the list of merge candidates by changing a motion attribute of a first merge candidate from a first value to a second value;
signaling or receiving a selection of a merge candidate from the modified list of merge candidates; and
encoding or decoding the current block by using the selected merge candidate.

2. The video coding method of claim 1, further comprising computing a template matching cost for each merge candidate in the list of merge candidates and reordering the list according to the computed template matching costs of the merge candidates in the list, wherein the selection of the merge candidate is based on the reordered list.

3. The video coding method of claim 1, wherein the list of merge candidates is modified when changing the motion attribute of the first merge candidate improves an estimated cost of using the first merge candidate to encode or decode the current block by more than a threshold.

4. The video coding method of claim 3, wherein the estimated cost is computed by determining a difference between a current template region neighboring the current block and a reference template region neighboring a reference block that is identified by the first merge candidate.

5. The video coding method of claim 1, wherein the list of merge candidates is modified by adding a second merge candidate having the modified motion attribute.

6. The video coding method of claim 1, wherein the list of merge candidates is modified by replacing the first merge candidate with a second merge candidate having the modified motion attribute.

7. The video coding method of claim 1, wherein changing the motion attribute of the first merge candidate comprises changing a reference index from identifying a first reference picture to identifying a second reference picture.

8. The video coding method of claim 7, wherein changing the motion attribute of the first merge candidate further comprises scaling a motion vector based on picture order count (POC) distances of the first reference picture and the second reference picture.

9. The video coding method of claim 1, wherein changing the motion attribute of the first merge candidate comprises changing a bi-prediction weighting index to select a different weighting for combining a first inter-prediction and a second inter-prediction.

10. The video coding method of claim 1, wherein the motion attribute of the first merge candidate being changed is one of an inter prediction direction, a reference index, a Bi-prediction with CU-level weight (BCW) index, a Local Illumination Compensation (LIC) flag, a half-pel filter used, and a Multi-Hypothesis Prediction (MHP) weight index.

11. A video decoding method comprising:
receiving data for a block of pixels to be decoded as a current block of a current picture of a video;
generating a list of merge candidates for the current block;
modifying the list of merge candidates by changing a motion attribute of a first merge candidate from a first value to a second value;
receiving a selection of a merge candidate from the modified list of merge candidates; and
reconstructing the current block by using the selected merge candidate.

12. A video encoding method comprising:
receiving data for a block of pixels to be encoded as a current block of a current picture of a video;
generating a list of merge candidates for the current block;
modifying the list of merge candidates by changing a motion attribute of a first merge candidate from a first value to a second value;
signaling a selection of a merge candidate from the modified list of merge candidates; and
encoding the current block by using the selected merge candidate to generate a prediction block.

13. An electronic apparatus comprising:
a video coder circuit configured to perform operations comprising:
receiving data for a block of pixels to be encoded or decoded as a current block of a current picture of a video;
generating a list of merge candidates for the current block;
modifying the list of merge candidates by changing a motion attribute of a first merge candidate from a first value to a second value;
signaling or receiving a selection of a merge candidate from the modified list of merge candidates; and
encoding or decoding the current block by using the selected merge candidate.
